(19) United States
(12) Patent Application Publication
(10) Pub. No.: US 2025/0104987 A1
(43) Pub. Date: Mar. 27, 2025

(54) MASS SPECTROMETRY DEVICE AND RF TUNING METHOD OF MASS SPECTROMETRY DEVICE

(71) Applicant: HITACHI HIGH-TECH CORPORATION, Tokyo (JP)

(72) Inventors: Hikaru Yamada, Tokyo (JP); Suguru Kondo, Tokyo (JP); Shinsuke Minata, Tokyo (JP); Yasushi Terui, Tokyo (JP)

(73) Assignee: HITACHI HIGH-TECH CORPORATION, Tokyo (JP)

(21) Appl. No.: 18/730,841

(22) PCT Filed: Jan. 25, 2022
(86) PCT No.: PCT/JP2022/002605

§ 371 Date: Jul. 22, 2024

(51) Int. Cl. H01J 49/02; H01J 49/42

(52) U.S. Cl. CPC H01J 49/022; H01J 49/025; H01J 49/42

(57) ABSTRACT

Provided is a mass spectrometry device capable of, when an abnormality in a voltage applied to an electrode is detected, easily isolating the location of the cause. This mass spectrometry device comprises a quadrupole electrode and a power supply circuit (200) for generating a radio frequency voltage to be applied to the quadrupole electrode, wherein the power supply circuit (200) is provided with an analog multiplier (205) and applies the radio frequency voltage generated by the power supply circuit to the quadrupole electrode in a state where the amplitude of an output signal from the analog multiplier (205) is controlled in an RF tuning mode so as to reach a target amplitude of the radio frequency voltage by feeding back the amplitude of the output signal from the analog multiplier (205).

### TECHNICAL FIELD

The present disclosure relates to a mass spectrometry device and an RF tuning method of a mass spectrometry device.

### BACKGROUND ART

In the related art, mass spectrometry is used in various fields, and is widely used in fields such as environment, pharmaceutical product, and food. Recently, with the widespread of DNA sequencers, attention is focused on a structural analysis of proteins produced from genetic information and modified proteins in cells, and new findings start to be obtained in drug discovery and clinical research.

A usage environment of a mass spectrometry device spreads from a research laboratory of a company or a university to a clinical laboratory of a hospital or the like, and the mass spectrometry device changes from a device used by a mass spectrometry expert to a device used by an expert in other fields as well. Therefore, there is a demand for a device that is not only highly sensitive which is one of features of mass spectrometry, but also simpler and more durable.

The mass spectrometry device is divided into a device that mainly performs a quantitative analysis and a device that mainly performs a qualitative analysis. A representative mass spectrometry device that mainly performs a quantitative analysis includes a triple quadrupole mass spectrometry device (hereinafter, referred to as “triple QMS”) having a plurality of quadrupole mass spectrometers in the device. The triple QMS has high quantitative analysis performance since the triple QMS has a feature that can allow specific ions of a measurement sample to continuously pass the triple QMS. On the other hand, the mass spectrometry device that mainly performs a qualitative analysis includes a time-of-flight mass spectrometer (hereinafter referred to as “TOF/MS”). Ions to be measured are caused to fly in a vacuum and a time required for the ions to reach a detector is measured to perform mass separation. Since an observable mass width is wide and a mass spectrum with high resolution is easily obtained, qualitative analysis performance is enhanced. Recently, a hybrid mass spectrometry device in which a plurality of QMSes and TOF/MSes are coupled is also commercialized, and there is a device that performs both a qualitative analysis and a quantitative analysis.

A mass spectrometer creates a vacuum inside a device, electrodes having various shapes are installed in the device, and ions introduced into the device are controlled and selected by an electric field. For example, a quadrupole mass spectrometer is also called a QMS or a mass filter, and has four columnar electrodes. In the quadrupole mass spectrometer, center axes of the respective electrodes are fixed in a manner of being arranged at vertices of a square. Positive and negative DC voltages ±U and radio frequency voltages ±V·cos ωt are superimposed on adjacent electrodes of the fixed columnar electrodes, and a voltage of ±U±V·cos ωt is applied. When charged ions are introduced into the electrodes, only ions having a specific mass-to-charge ratio (an m/z value) are stably vibrated and pass through the electrodes depending on a voltage and a frequency applied to the electrodes. On the other hand, other ions vibrate strongly while passing the electrodes, and cannot pass through the electrodes due to collision or the like. A mass spectrum is obtained by linearly changing a radio frequency voltage while keeping a ratio between a DC voltage and the radio frequency voltage constant.

As described above, since the mass spectrometry device controls ions by an electric field, accuracy stability of the DC voltage and the radio frequency voltage applied to the electrodes is directly linked to device performance such as mass axis stability. Therefore, specifications required for the DC voltage and the radio frequency voltage are strict, and accuracy stability of a ppm order is required for a voltage applied to a mass filter.

A usage environment spreads from a research laboratory of a company or a university to a clinical laboratory of a hospital or the like, and the device must be operated within a temperature range of, for example, 5° C. to 35° C. When a surrounding temperature of the mass spectrometry device changes, a temperature of a control board that generates the DC voltage and the radio frequency voltage also changes. Therefore, a change in an environmental temperature causes a change in the DC voltage and the radio frequency voltage, which results in a fluctuation in a mass axis.

PTL 1 discloses a mass spectrometry device that prevents displacement of a mass axis when a surrounding temperature changes.

### CITATION LIST

### Patent Literature

PTL 1: JP2014-146525A

### SUMMARY OF INVENTION

### Technical Problem

In PTL 1, calculation of a feedback control for controlling an amplitude of a radio frequency voltage (an RF voltage) applied to an electrode to a target value is performed by digital calculation that is not affected by a temperature change.

On the other hand, when a power supply of the mass spectrometry device is configured such that the radio frequency voltage applied to the electrode is generated using an analog multiplier, circuit elements for obtaining feedback of the amplitude of the RF voltage include many circuit elements that cause errors. Therefore, when a failure is found in the amplitude of the RF voltage, it is difficult to specify a location of a cause.

A main object of the present disclosure is to provide a mass spectrometry device that can easily specify a location of a cause when an abnormality occurs in a radio frequency voltage applied to an electrode.

### Solution to Problem

In order to solve the above problem, for example, a configuration described in the claims is adopted.

The present specification includes multiple solutions to the above problem, and examples thereof include a mass spectrometry device that includes a quadrupole electrode and a power supply circuit configured to generate a radio frequency voltage to be applied to the quadrupole electrode. The power supply circuit includes an analog multiplier. In an RF tuning mode, an amplitude of an output signal of the analog multiplier is fed back, and the radio frequency voltage generated by the power supply circuit is applied to the quadrupole electrode in a state where the amplitude of the output signal of the analog multiplier is controlled to be a target amplitude of the radio frequency voltage.

### Advantageous Effects of Invention

According to the present disclosure, provided is a mass spectrometry device that can easily specify a location of a cause when an abnormality occurs in a voltage applied to an electrode. Problems, configurations, and effects other than those described above will be clarified by description of the following embodiments.

### BRIEF DESCRIPTION OF DRAWINGS

FIG. 1 is a diagram showing a device configuration of a mass spectrometry device.

FIG. 2 is a diagram showing a radio frequency voltage circuit system (a measurement mode) of the mass spectrometry device.

FIG. 3 is a diagram showing a radio frequency voltage circuit system (an RF tuning mode) of a mass spectrometry device in the related art.

FIG. 4 is a diagram showing a first example of a radio frequency voltage circuit system (an RF tuning mode).

FIG. 5 is a diagram showing a second example of the radio frequency voltage circuit system (the RF tuning mode).

FIG. 6 is a diagram showing a third example of the radio frequency voltage circuit system (the RF tuning mode).

FIG. 7 is a configuration diagram showing a network according to Embodiment 2.

### DESCRIPTION OF EMBODIMENTS

### Embodiment 1

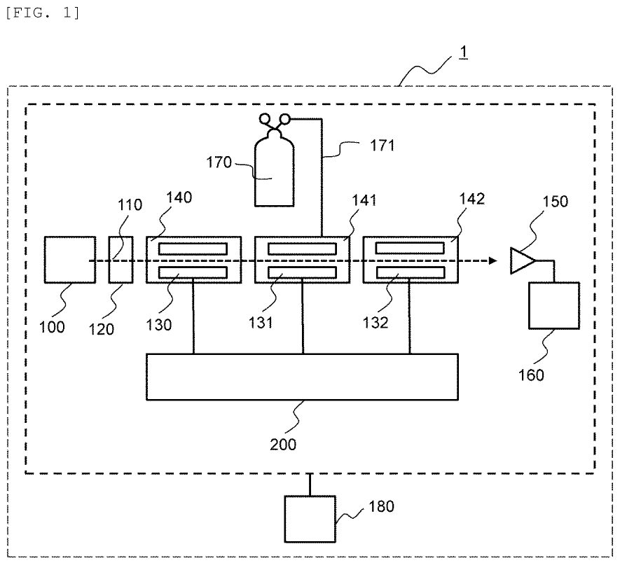

FIG. 1 is a diagram showing a device configuration of a mass spectrometry device 1 according to Embodiment 1.

A measurement sample sent by a pump such as a liquid chromatograph is ionized by an ion source 100. Since the ion source 100 operates at atmospheric pressure and a mass spectrometer operates in vacuum, ions 110 are introduced into the mass spectrometer (here, a triple QM) through an atmosphere and vacuum interface 120.

Although the ions 110 generated from the ion source 100 has various masses, in a first quadrupole electrode portion 140, a power supply circuit 200 applies, to a first quadrupole electrode 130 inside the first quadrupole electrode portion 140, a radio frequency voltage and a DC voltage for allowing target ions to pass, thereby selectively allowing only target ions derived from the measurement sample to pass.

A collision gas 170 (a nitrogen gas, an argon gas, or the like) for dissociating the target ions is introduced into a second quadrupole electrode portion 141 from a supply source through a gas line 171. Usually, only an AC voltage is applied by the power supply circuit 200 to a second quadrupole electrode 131 inside the second quadrupole electrode portion 141. Accordingly, there is no mass selectivity, and the target ions that passed through the first quadrupole electrode portion 140 and the collision gas 170 collide with each other to generate fragment ions. The generated fragment ions pass through the second quadrupole electrode portion 141 and enter a third quadrupole electrode portion 142.

In the third quadrupole electrode portion 142, the power supply circuit 200 applies, to a third quadrupole electrode 132 inside the third quadrupole electrode portion 142, a radio frequency voltage and a DC voltage for allowing target fragment ions to pass, thereby allowing only the target fragment ions to pass through the third quadrupole electrode portion 142. The target fragment ions that passed through the third quadrupole electrode portion 142 are detected by a detector 150. A detection signal is transmitted to a data processing unit 160 to perform mass spectrometry.

Control is performed by a control unit 180. The control unit 180 may be implemented by a single device or a plurality of devices. The control unit 180 may be integrated with the data processing unit 160. The control unit 180 may be incorporated in the mass spectrometry device 1 or may be provided outside the mass spectrometry device 1.

FIG. 1 shows an example of the mass spectrometry device 1 including a triple QMS, but the present disclosure can also be applied to a single QMS in which a single quadrupole electrode is installed and a quadrupole mass spectrometer.

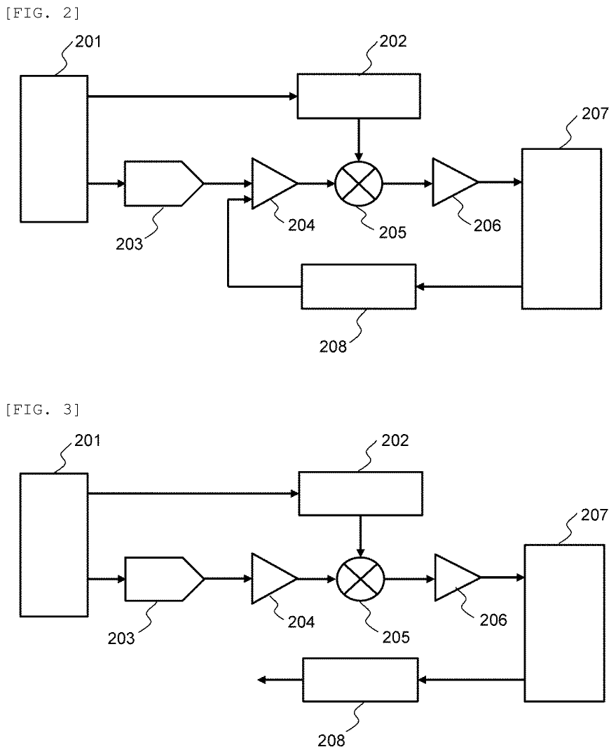

The power supply circuit 200 includes a radio frequency voltage circuit system that controls a radio frequency voltage. FIG. 2 shows the radio frequency voltage circuit system of the mass spectrometry device 1. FIG. 2 shows a circuit configuration of the radio frequency voltage circuit system when mass spectrometry is performed, and the circuit configuration is called a radio frequency voltage circuit system in a measurement mode.

A resonance circuit 207 finally generates an RF voltage to be applied to a quadrupole electrode. The resonance circuit 207 is, for example, a transformer having a primary coil and a secondary coil. When a radio frequency current flows from an RF drive circuit 206 to the primary coil, an RF voltage is generated in the secondary coil, and the generated radio frequency voltage is applied to the quadrupole voltage connected to the secondary coil. A field programmable gate array (FPGA) 201 is a radio frequency voltage generation control unit that controls the generation of the RF voltage applied to the quadrupole electrode. The FPGA 201 outputs a control signal for operating a sine wave generation circuit 202 and a target amplitude signal indicating a target amplitude of an RF voltage applied to the resonance circuit 207. The sine wave generation circuit 202 receives the control signal from the FPGA 201 and outputs a sine wave, and a digital analog converter (DAC, DA converter) 203 receives the target amplitude signal from the FPGA 201 and outputs a voltage according to the target amplitude signal. The sine wave generated by the sine wave generation circuit 202 and an amplification voltage for amplifying the sine wave are multiplied by an analog multiplier 205 to obtain an amplified sine wave.

An amplitude of the RF voltage applied to the quadrupole electrode fluctuates with a mass spectrometry operation. In order to prevent this fluctuation, the radio frequency voltage circuit system performs feedback control on the amplitude of the RF voltage. Therefore, a first proportional integral (PI) control circuit 204 and a detection circuit (a second detection circuit) 208 are provided. The detection circuit 208 detects the amplitude of the RF voltage that is generated by the resonance circuit 207 and is applied to the quadrupole voltage. The first PI control circuit 204 controls the amplification voltage for amplifying the sine wave in the analog multiplier 205 according to a difference between a target amplitude from the DAC 203 and an actual amplitude fed back from the detection circuit 208.

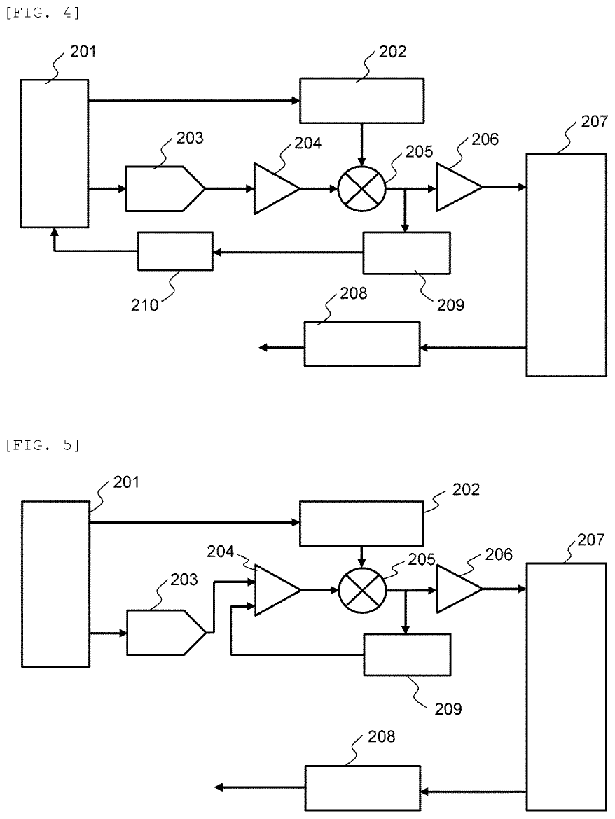

FIG. 3 is a diagram showing a circuit configuration in the related art when performing RF tuning in the radio frequency voltage circuit system shown in FIG. 2. The circuit configuration n this case is called a radio frequency voltage circuit system in an RF tuning mode. The RF tuning mode is a mode in which a feedback control from the detection circuit 208 is cut off in a state where mass spectrometry is not performed, and it is confirmed whether an error between a target amplitude and an actual amplitude of the RF voltage applied to the quadrupole electrode is within a predetermined allowable range based on the target amplitude signal from the FPGA 201. The actual amplitude of the RF voltage can be confirmed by monitoring an output of the detection circuit 208. When the error of the RF voltage exceeds the allowable range, an engineer determines a correction amount (offset) of the target amplitude signal output from the FPGA 201 so that the error of the RF voltage falls within the allowable range. During mass spectrometry, an RF voltage is generated according to an offset target amplitude signal.

At the time of RF tuning, the radio frequency voltage circuit system switches a circuit connection and operates without being subject to a feedback control performed by the first PI control circuit 204, a voltage corresponding to the target amplitude signal from the DAC 203 is input to the analog multiplier 205, and an amplitude of the RF voltage applied to the quadrupole electrode, which is output from the detection circuit 208, is monitored.

A voltage adjustment according to such offset is performed when the error of the RF voltage is relatively small. When the error of the RF voltage is large, it is assumed that an abnormality occurs on a device side, and therefore it is necessary to carry out maintenance of the mass spectrometry device rather than performing an adjustment according to the offset. However, in the circuit configuration shown in FIG. 3, the RF voltage is applied to the resonance circuit 207 through the analog multiplier 205 and the RF drive circuit 206, and is detected through an RF detection capacitor and an RF amplitude detection circuit provided in the detection circuit 208. Therefore, when a relatively large error is detected in the RF voltage in the RF tuning, it is not easy to specify a cause of an abnormality.

Here, in the circuit configuration shown in FIG. 3, a circuit element having a high possibility of generating a large error which leads to occurrence of an abnormality in the RF voltage is a quadrupole electrode connected to the analog multiplier 205 and the resonance circuit 207. The analog multiplier 205 may vary a multiplication output depending on an individual difference and may cause an abnormality in the RF voltage. The abnormality caused by the analog multiplier 205 can be eliminated by replacing a component. On the other hand, the quadrupole electrode may cause an abnormality in the RF voltage due to adhesion of dirt to the electrode during mass spectrometry. The abnormality caused by the quadrupole electrode can be eliminated by cleaning the electrode. Here, the radio frequency voltage circuit system according to Embodiment 1 can specify whether there is an abnormality of the analog multiplier 205 or other abnormalities in the RF tuning mode. Accordingly, when an abnormality occurs in the RF voltage at the time of RF tuning, it is possible to easily specify a cause e of the abnormality and select an appropriate maintenance method.

FIG. 4 shows a first example of the radio frequency voltage circuit system (the RF tuning mode) according to Embodiment 1. In a circuit configuration example shown in FIG. 4, a feedback circuit for feeding back an output signal of the analog multiplier 205 to an upstream side is newly provided. Among circuit elements shown in FIG. 4, the same circuit elements as those in the circuit configuration shown in FIG. 2 are denoted by the same reference numerals, and redundant description is omitted. In the circuit configuration at the time of mass spectrometry (a measurement mode), the feedback circuit (a detection circuit 209 and an ADC 210) newly added in FIG. 4 is cut off, and an output from the detection circuit 208 is input to the first PI control circuit 204. That is, the radio frequency voltage circuit system in the measurement mode has the same circuit configuration as that shown in FIG. 2. The same applies to other examples of the radio frequency voltage circuit system (the RF tuning mode) to be described later.

Specifically, the feedback circuit causes the detection circuit (the first detection circuit) 209 to detect an amplitude of an output signal of the analog multiplier 205, causes the ADC (an analog digital converter, an AD converter) 210 to perform AD conversion, and feeds back a result to the FPGA 201. A value measured by the detection circuit 209 is AD converted and read into the FPGA 201, and the FPGA 201 controls the amplitude of the output signal of the analog multiplier 205 to a desired amplitude by correcting an output of the DAC 203 or an amplitude of the sine wave generation circuit 202 based on a difference between an output value of the ADC and a target amplitude signal such that the amplitude of the output signal of the analog multiplier 205 becomes the desired amplitude.

Accordingly, it is guaranteed that an individual difference from the analog multiplier 205 does not cause an abnormality in the amplitude of the RF voltage. When there is still an abnormality in the amplitude of the RF voltage from the detection circuit 208, it can be determined that the abnormality is in the quadrupole electrode or in a power supply circuit downstream of the analog multiplier 205. Alternatively, an abnormality caused by the analog multiplier 205 can be detected by comparing the target amplitude signal with an output of the ADC 210. In this manner, the analog multiplier 205 and the quadrupole electrode which are main factors causing occurrence of an abnormality in the RF voltage are distinguished from each other, and whether there is an abnormality in each component can be detected, which makes it easier to maintain the device.

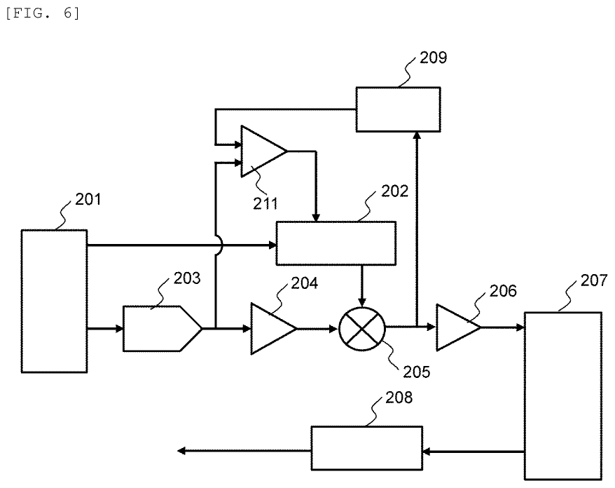

FIG. 5 shows a second example of the radio frequency voltage circuit system (the RF tuning mode) according to Embodiment 1. A basic circuit configuration in the second example is similar to that in the first example. A method of feeding back an amplitude of the output signal of the analog multiplier 205 is different from that in the first example.

In a feedback circuit in the second example, specifically, an amplitude of the output signal of the analog multiplier 205 is detected by the detection circuit 209 and fed back to the first PI control circuit 204. By this feedback, a value measured by the detection circuit 209 is input to the first PI control circuit 204, and a sine wave from the sine wave generation circuit 202 is amplified based on a difference between an output of the DAC 203 and an amplitude of the output signal of the analog multiplier 205, thereby controlling the amplitude of the output signal of the analog multiplier 205 to a desired amplitude. As a feedback circuit, an example is shown in which an input to the first PI control circuit 204 is switched between a measurement mode and an RF tuning mode, but a PI control circuit for the RF tuning mode may be provided separately from the first PI control circuit 204 used in the measurement mode.

According to the second example, it is possible to specify the analog multiplier 205 and the quadrupole electrode which are main factors causing the occurrence of an abnormality in the RF voltage and detect whether there is an abnormality in each component, so that maintenance of the device can be easily performed.

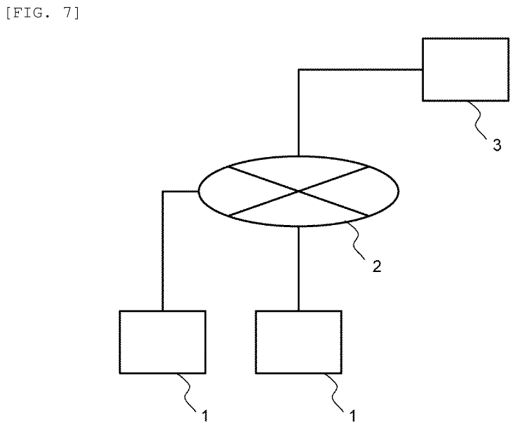

FIG. 6 shows a third example of the radio frequency voltage circuit system (the RF tuning mode) according to Embodiment 1. A basic circuit configuration in the third example is similar to that in the first example. A method of feeding back an amplitude of an output signal of the analog multiplier 205 is different from that in the first example or the second example.

In a feedback circuit in the third example, specifically, an amplitude of the output signal of the analog multiplier 205 is detected by the detection circuit 209 and fed back to a second PI control circuit 211. An output of the DAC 203 and an amplitude of the output signal of the analog multiplier 205 detected by the detection circuit 209 are input to the second PI control circuit 211, and an output of the second PI control circuit 211 is input to the sine wave generation circuit 202. The sine wave generation circuit 202 adjusts an amplitude of a generated sine wave based on a difference between the output of the DAC 203 and the amplitude of the output signal of the analog multiplier 205, thereby controlling the amplitude of the output signal of the analog multiplier 205 to a desired amplitude.

According to the third example, it is possible to specify the analog multiplier 205 and the quadrupole electrode which are main factors causing the occurrence of an abnormality in the RF voltage and detect whether there is an abnormality in each component, so that maintenance of the device can be easily performed.

### Embodiment 2

FIG. 7 is a configuration diagram showing a network of a mass spectrometry device management system according to Embodiment 2.

In Embodiment 2, the mass spectrometry device 1 according to Embodiment 1 is connected to a server (an information processing device) 3 via a network 2. The control unit 180 of the mass spectrometry device 1 monitors an operation status of the mass spectrometry device 1 including an output of the detection circuit 208 and an output of the detection circuit 209, and reports data indicating the operation status to the server 3 via the network 2. It is assumed that the data indicating the operation status includes output data of the detection circuit 208 and output data of the detection circuit 209. The server 3 stores the data. An engineer analyzes the data, so that it is possible to confirm an operation status of the mass spectrometry device 1 and predict a failure.

Accordingly, it is possible to rapidly cope with occurrence of an abnormality in the mass spectrometry device 1 and improve availability of the mass spectrometry device 1. Such kind of data can be easily used for improving and developing a device.

Data analysis can be automatically performed using an AI program running on a processor of the server 3. For example, based on changes over time in the output of the detection circuit 208 and changes over time in the output of the detection circuit 209 in the mass spectrometry device 1 in operation, AI can detect occurrence of a failure in a voltage applied to the quadrupole electrode, and can specify whether the failure is caused by a circuit downstream of the resonance circuit 207 or an individual difference of the analog multiplier 205. In addition, AI can detect a sign of the occurrence of a failure in a voltage applied to the quadrupole electrode based on the changes over time in the output of the detection circuit 208 and the changes over time in the output of the detection circuit 209 in the mass spectrometry device 1 in operation.

When AI detects the occurrence of a failure or a sign of the occurrence of a failure, the AI can transmit an instruction to the mass spectrometry device 1 via the network 2 so as to display a failure situation on a display unit (not shown) of the mass spectrometry device 1, and can instruct an engineer on how to cope with the failure. Accordingly, when there is a failure in the mass spectrometry device 1, it is possible to reduce the number of steps in which a user of the mass spectrometry device 1 checks a failure situation and makes contact with an engineer, and the engineer goes to an installation location of the device and investigates an occurrence location of the failure, thereby improving availability of the mass spectrometry device 1.

As described above, according to the technique of the present disclosure, it is possible to easily specify a location of a cause when a failure occurs in a voltage applied to an electrode of the mass spectrometry device.

When a failure occurs at the time of assembly or operation of the device, it is possible to facilitate specification of an occurrence location of the failure, thereby reducing required man-hours of an engineer who performs an analysis. For a user of the device, a device stop time due to the occurrence of the failure in the device is reduced.

The invention is not limited to the embodiments described above, and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to the configuration of a certain embodiment. A part of a configuration according to each embodiment may be added to, deleted from, or replaced with another configuration.

### REFERENCE SIGNS LIST

1: mass spectrometry device
2: network
3: server
100: ion source
110: ion
120: interface
130: first quadrupole electrode
131: second quadrupole electrode
132: third quadrupole electrode
140: first quadrupole electrode portion
141: second quadrupole electrode portion
142: third quadrupole electrode portion
150: detector
160: data processing unit
170: collision gas
171: gas line
180: control unit
200: power supply circuit
201: FPGA
202: sine wave generation circuit
203: DAC
204: first PI control circuit
205: analog multiplier
206: RF drive circuit
207: resonance circuit
208: detection circuit (second detection circuit)
209: detection circuit (first detection circuit)
210: ADC
211: second PI control circuit

1. A mass spectrometry device comprising:
a quadrupole electrode; and
a power supply circuit configured to generate a radio frequency voltage to be applied to the quadrupole electrode, wherein
the power supply circuit includes a radio frequency voltage generation control unit configured to output a target amplitude signal for setting a target amplitude of the radio frequency voltage, a sine wave generation circuit, an analog multiplier configured to multiply a sine wave generated by the sine wave generation circuit by an amplification voltage for amplifying the sine wave, and a first detection circuit configured to detect an amplitude of an output signal of the analog multiplier, and
in an RF tuning mode, the amplitude of the output signal of the analog multiplier detected by the first detection circuit is fed back, and the radio frequency voltage generated by the power supply circuit is applied to the quadrupole electrode in a state where the amplitude of the output signal of the analog multiplier is controlled to be the target amplitude of the radio frequency voltage set by the radio frequency voltage generation control unit.

2. The mass spectrometry device according to claim 1, wherein
the power supply circuit includes a DA converter configured to perform DA conversion on the target amplitude signal to generate a voltage corresponding to the target amplitude signal, and a second detection circuit configured to detect an amplitude of the radio frequency voltage applied to the quadrupole electrode,
in a measurement mode, the amplification voltage is set according to a difference between the amplitude of the radio frequency voltage applied to the quadrupole electrode detected by the second detection circuit and the voltage corresponding to the target amplitude signal, and
in the RF tuning mode, the amplitude of the radio frequency voltage applied to the quadrupole electrode detected by the second detection circuit is monitored.

3. The mass spectrometry device according to claim 2, wherein
the power supply circuit includes an AD converter configured to perform AD conversion on an amplitude of an output signal of the first detection circuit, and
in the RF tuning mode, the voltage corresponding to the target amplitude signal is set as the amplification voltage, the radio frequency voltage generation control unit receives an output value of the AD converter, corrects the target amplitude signal based on a difference between the output value of the AD converter and the target amplitude signal, or corrects an amplitude of the sine wave generated by the sine wave generation circuit.

4. The mass spectrometry device according to claim 2, wherein
in the RF tuning mode, the amplification voltage is set according to a difference between an amplitude of an output signal of the analog multiplier detected by the first detection circuit and the voltage corresponding to the target amplitude signal.

5. The mass spectrometry device according to claim 2, wherein
in the RF tuning mode, the sine wave generation circuit controls an amplitude of the generated sine wave according to a difference between an amplitude of an output signal of the analog multiplier detected by the first detection circuit and the voltage corresponding to the target amplitude signal.

6. An RF tuning method of a mass spectrometry device including a quadrupole electrode and a power supply circuit that generates a radio frequency voltage to be applied to the quadrupole electrode, wherein
the power supply circuit includes a radio frequency voltage generation control unit configured to output a target amplitude signal for setting a target amplitude of the radio frequency voltage, a sine wave generation circuit, an analog multiplier configured to multiply a sine wave generated by the sine wave generation circuit by an amplification voltage for amplifying the sine wave, a first detection circuit configured to detect an amplitude of an output signal of the analog multiplier, and a second detection circuit configured to detect an amplitude of the radio frequency voltage applied to the quadrupole electrode,
the amplitude of the output signal of the analog multiplier detected by the first detection circuit is fed back, and the radio frequency voltage generated by the power supply circuit is applied to the quadrupole electrode in a state where the amplitude of the output signal of the analog multiplier is controlled to be the target amplitude of the radio frequency voltage set by the radio frequency voltage generation control unit, and
an amplitude of the radio frequency voltage applied to the quadrupole electrode, which is detected by the second detection circuit, is monitored.

7. The RF tuning method according to claim 6, wherein
the target amplitude signal output by the radio frequency voltage generation control unit is offset according to an error between the target amplitude of the radio frequency voltage and the amplitude of the radio frequency voltage applied to the quadrupole electrode, which is detected by the second detection circuit.
